(19) United States
(12) Patent Application Publication
(10) Pub. No.: US 2014/0019177 A1
(43) Pub. Date: Jan. 16, 2014

(54) ON-BOARD ONWARDS TRAVEL ENABLEMENT KIOSK (OBOTEK)

(71) Applicant: Cubic Corporation, San Diego, CA (US)

(72) Inventor: Gavin R. Smith, Crawley (GB)

(21) Appl. No.: 13/942,366

(22) Filed: Jul. 15, 2013

Related U.S. Application Data
(60) Provisional application No. 61/672,194, filed on Jul. 16, 2012.

(51) Int. Cl. G06Q 10/02

(52) U.S. Cl. CPC G06Q 10/025
USPC 705/6

(57) ABSTRACT

A method/apparatus/system for onboard onwards travel ticketing is provided. Onboard onwards travel ticketing is provided by determining current location of a mode of transit, determining the destination of a user, identifying purchase options relevant to the destination, and providing the purchase options to the user. The purchase options can be a subset of all purchase options, which subset can be selected according to one or several bounding rules, and can be options for further travel. The user can then select one or several of the purchase options and can transact the purchase of one or several of the purchase options with the apparatus and/or system.

### CROSS-REFERENCES TO RELATED APPLICATIONS

This application claims the benefit of U.S. Provisional Application No. 61/672,194, filed on Jul. 16, 2012, and entitled “On-Board Onwards Travel Enablement Kiosk (OBOTEK), the entirety of which is hereby incorporated by reference herein.

### BACKGROUND OF THE INVENTION

This application relates to ticket vending, ticket vending machines, and systems for ticket vending.

### BRIEF SUMMARY OF THE INVENTION

In one embodiment, the present disclosure provides a system for dynamic ticket vending in an in-transit environment of the mode of transit. In some embodiments, the system can include a terminal that has a user interface that allows the user to provide information to and receive information from the terminal. The terminal can further include a processor that can receive user destination information. The user destination information can identify one of an intermediate destination and a final destination. The processor can identify the current location of the mode of transit. The system can include a central ticketing system. The central ticketing system can include a processor that can receive current location information. In some embodiments, the current location information can be received from the terminal. The processor within the central ticketing system can generate a dynamic schedule that can identify one of an adjusted arrival time and an adjusted departure time for the mode of transit. The process within the central ticketing system can identify relevant connection options and/or purchase options according to the dynamic schedule and the destination information. These connection options can be provided to the user via the terminal, and the user can select one or several of the connection options and the purchase options.

In one embodiment, the present disclosure provides a method for dynamic ticket vending in an in-transit environment of a mode of transit. The method can include identifying the current location of the mode of transit and identifying a user destination. The user destination can be one of an intermediate destination and a final destination. The identifying of the user destination can include identifying the user, retrieving stored user destination information, determining potential destinations for the mode of transit, and comparing potential destinations for the mode of transit with stored user destination information. The stored user destination information can identify destinations previously visited by the user. The method can include generating a dynamic schedule. The dynamic schedule can identify estimated arrival or departure times of the mode of transit at one or several locations. This schedule can be based on collected information relating to the mode of transit. The method can further include identifying relevant connection options according to the dynamic schedule and the destination information.

In one embodiment, the present disclosure provides a non-transitory computer readable medium that includes code that, when executed, implements a method for dynamic ticket vending in an in-transit environment of a mode of transit. The method can include identifying the current location of the mode of transit and identifying a user destination. The user destination can be one of an intermediate destination and a final destination. The identifying of the user destination can include identifying the user, retrieving stored user destination information, determining potential destinations for the mode of transit, and comparing potential destinations for the mode of transit with stored user destination information. In some embodiments, the stored user destination information can identify destinations previously visited by the user. The method can include generating a dynamic schedule. The dynamic schedule can identify estimated arrival or departure times of the mode of transit at one or several locations. This schedule can be based on collected information relating to the mode of transit. The method can include identifying relevant connection options according to the dynamic schedule and the destination information.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 is a block diagram of an embodiment of a transit system

FIG. 2 is a block diagram of an embodiment of a station system.

FIG. 3 is a perspective view of an embodiment of a transit vending machine.

FIG. 4 is a perspective view of a second embodiment of a transit vending machine.

FIG. 5 is a schematic illustration of one embodiment of a transit vending machine.

FIG. 6 is a flowchart illustrating one embodiment of a process for onboard onwards travel ticketing.

FIG. 7 is a flowchart illustrating another embodiment of a process for onboard onwards travel ticketing.

FIG. 8 is a flowchart illustrating one embodiment of a process for receiving and/or determining destination identification information.

FIG. 9 is a flowchart illustrating one embodiment of a process for receiving and/or determining location information.

FIG. 10 is a flowchart illustrating one embodiment of a process for receiving and/or determining purchase options.

FIG. 11 depicts a block diagram of an embodiment of a computer system.

FIG. 12 depicts a block diagram of an embodiment of a special-purpose computer system.

In the appended figures, similar components and/or features may have the same reference label. Where the reference label is used in the specification, the description is applicable to any one of the similar components having the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

In the following description, for the purposes of explanation, numerous specific details are set forth in order to provide a thorough understanding of various embodiments. It will be apparent, however, to one skilled in the art that various embodiments may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosed systems and methods as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

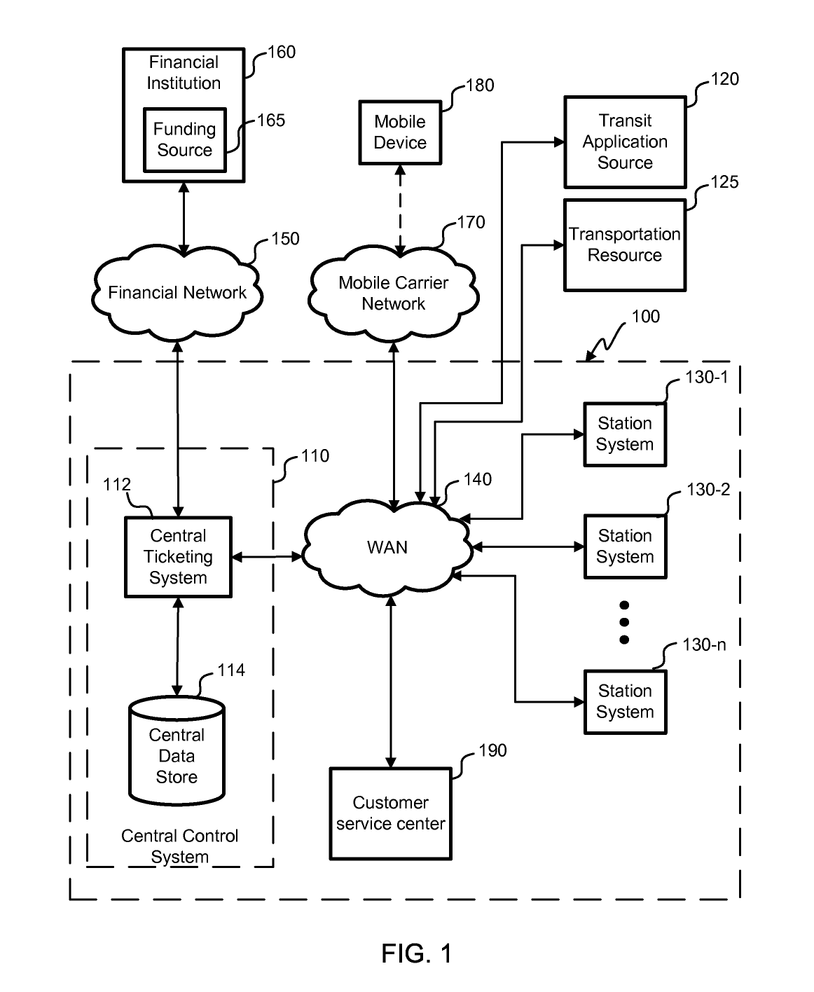

FIG. 1 illustrates a block diagram of an embodiment of a transit system 100, in communication with other systems. The transit system 100 can be used with any desired form of transit including, for example, subway, bus, ferry commuter rail, para-transit, airplane, etc., or any combination thereof, and can be used to coordinate and/or control the operation of the other systems in providing services, including, transportation services.

The transit system 100 can include a central control system 110. The central control system 110 can include one or more servers and/or other computing systems having processors, memories, and network interfaces for processing and communicating information.

In the specific embodiment shown in FIG. 1, the central control system can include a central ticketing system 112. The central ticketing system 112 can comprise one or more servers and/or other computing systems having processors, memories, and network interfaces for processing and communicating information. In some embodiments, the central ticketing system 112 can be configured to provide information relating to ticketing, receive information relating to ticketing, and/or to track information relating to ticketing. In some embodiments, the central ticketing system 112 can store information within a central data store 114. This information can relate to purchasing habits of the user, purchasing habits or several users, available tickets, sold tickets, and/or any other information. It will be recognized that such a transit system 100 can be enabled for use in applications beyond transit, such as transportation systems (e.g., airline systems, car rental systems, etc.).

The transit system 100 can include one or several station systems 130. In some embodiments, the station system 130 can comprise one or several systems and/or devices located within the station and/or within a mobile environment, which systems and/or devices can be used for ticketing and/or access control. Station systems 130 can gather information regarding transactions and communicate the information to the central ticketing system 112 using a wide area network (WAN) 140. The WAN 140 can include one or more networks, such as the internet, which one or more networks may be public, private, or a combination of both. The WAN 140 can be packet-switched or circuit-switched connections using telephone lines, coaxial cable, optical fiber, wireless communication, satellite links, and/or other mechanisms for communication. Communication between the station systems 130 and the central control system 110 may be in real time or periodic. Thus, the usage of fare media throughout the transit system 100 can be tracked. In some embodiments, changes in schedules, ticket prices, and delay notifications can be communicated from the central ticketing system 112 to the station systems 130 via the WAN 140.

In some embodiments, the transit system 100 can include a customer service center 190 that can be maintained and/or provided by the transit service provider of the transit system 100. In some embodiments, the customer service center 190 can comprise a call center and/or any other source of customer support and/or customer service.

The user can be identifiable and/or identified by the transit system 100. In some embodiments, the user can have, for example, a user account. The user account can comprise information regarding a certain user of the transit system 100, such as a name, address, phone number, email address, user identification (such as a unique identifier of the user or other user ID), passcode (such as a password and/or personal identification number (PIN)), an identification code associated with a fare media used to identify a user and/or a transit user account (such as a primary account number (PAN)), information regarding user preferences and user opt-in or opt-out selections for various services, product(s) associated with the transit user account, a value and/or credit associated with the product(s), information regarding a funding source for the transit user account, and more. The transit user account can further comprise funding and transaction information, such as product information, a funding source, and a payment amount.

A transit user may request a transit user account and provide the information listed above by phone (such as a call to the customer service center 190 maintained and/or provided by the transit service provider of the transit system 100), on the Internet, at ticket booth, at a ticket vending machine, or by other means. The central ticketing system 112 can use the information provided by the user to create the transit user account, which can be stored and/or maintained on a database, such as the central data store 114 of the central control system 110.

The transit user account may include information regarding a user's preferences with regard to funding. For example, the transit user account may be configured to automatically draw a certain amount of funds from a funding source 165 each month to pay for a certain transit product or service, or to add value and/or credits to an existing transit product or service. The value and/or credits can include a monetary credit, a usage credit, and/or a usage period. Additionally or alternatively, the transit user account can be configured to automatically withdraw a certain amount of funds from the funding source 165 to add additional value and/or credits to an existing product when the value and/or credits of the existing product drops below a certain threshold level. Various other configurations are allowable by the transit user account. It will be understood that other systems of the transit system 100, such as a station system 130, may draw funds from a funding source 165. Moreover, because cash payments can also be used to fund transactions associated with a transit user account, the transit user account may not require funding source 165.

In some embodiments, the transit system 100 can transact business with the funding source 165 via a financial institution 160. In some embodiments, this transaction can occur via financial network 150, and in some specific embodiments, the central ticketing system 112 can communicate with a financial network 150 to complete a transaction with the funding source 165. In some embodiments, for example, this transaction can include verifying that sufficient funds are included within the funding source 165 to complete the transaction, requesting payment of funds associated with user selected purchase, verifying the identity of the funding source 165 and/or the financial institution 160, verifying the identity of the requesting central ticketing system 112, and receiving the funds in response to the completion of the transaction.

The funding source 165 can provide funding to allow purchase of products from the transit system 100. The funding source can be external to the central control system 110 and can be maintained, for example, by the financial institution 160. Such a funding source 165 may include a savings or checking account, a prepaid account, a credit account, an e-commerce account (such as a PAYPAL® account), or more, which can transfer funds via automated clearing house (ACH) or other means. In some embodiments in which a user is associated with a user account, the user account can include information about the funding source 165. If the transit user account comprises information regarding a funding source 165, the central ticketing system 112 can use the information to fund purchases or other transactions of a user of the transit system 100. These transactions can be made at stations, on the internet, by phone, text, email, or a variety of other different ways, and transaction information can then be sent to the central ticketing system 112 to update the transit user account associated with the transactions and reconcile payments and purchases with the funding source 165. The central ticketing system 112 can communicate with the financial institution 160 (or other entity maintaining the funding source 165) through a financial network 150.

The central ticketing system's reconciliation with the funding source 165 may vary depending on one or more products associated with the user account and the functionality desired by a transit services provider. For example, the user account may include a running balance mirroring a balance of the funding source 165. In such a case, transactions, such as passage of a user at an access control point (such as a turnstile, faregate, platform validator, para-transit vehicle, bus, conductor handheld unit, or fare box at an entry, exit, or other location of a transit station) can be recorded and/or tracked by the central ticketing system 112 and reconciled, on a per-transaction basis and/or collectively with other transactions. Along these lines, the central ticketing system 112 may reconcile payment for the transactions with the funding source 165 as the transactions are received and/or on a scheduled basis, such as on an hourly or daily basis.

Additionally or alternatively, when transit products or services are associated with a user account, the central ticketing system 112 can draw funds from a funding source 165 less frequently. For example, a transit product can include a certain number of rides or an unlimited number of rides for a certain period of time. In this case, the central ticketing system 112 can track transactions associated with the passage of a user at an access control point (i.e., transactions in the transit system associated with a ride), but may only need to reconcile with the funding source 165 once, for the purchase of the transit product.

In some embodiments, transit system 100 can communicate with one or several users operating a mobile device 180. The mobile device 180 may be communicatively coupled with the central control system 110. Such a mobile device may be a smart phone or other mobile phone (including a near-field-communication (NFC)-enabled mobile phone), a tablet personal computer (PC), a personal digital assistant (PDA), an e-book reader, or other device. In transit system 100, a communicative link from mobile device 180 to central ticketing system 112 can be provided by a mobile carrier network 170 in communication with WAN 140. Mobile device 180 can thereby communicate with the central ticketing system 112 to access and/or manage information of a transit user account. Furthermore, the central ticketing system 112 can send messages to the mobile device 180, providing transit, account, and/or advertisement information to a user of the transit system 100 in possession of the mobile device 180. Such messages may be based on, among other things, opt-in or opt-out selections and/or other user preferences as stored in a transit user account. In some embodiments, the mobile carrier network 170 can comprise any mobile communication network including, for example, cellular network, radio network, and/or the like.

A transit user can use the mobile device 180 to download a transit application from a transit application source 120. The transit application source 120 may be an application store or website provided by a mobile carrier, the hardware and/or software provider of the mobile device 180, and/or the transit service provider. The transit application can be uploaded or otherwise provided to transit application source 120 by the transit service provider. According to some embodiments, the transit application can provide additional functionality to the mobile device 180, including enabling an NFC-enabled mobile device to be used as fare media and access control points of the transit system 100.

In some embodiments, the transit system 100 can communicate with a transportation resource 125. The transportation resource 125 can comprise a source of information relating to one or several modes of transit. This information can include, for example, one or several schedules, including, for example, the departure and/or arrival times of one or several modes of transit from one or several locations, price information, current transit location information including, for example, the current location of an en route mode of transit, disruption information including, for example, data relating to any circumstances or conditions that will result in and/or have resulted in an arrival and/or departure time deviation from the schedule, a dynamic schedule which can, for example, identify whether the mode of transit is ahead, behind, or on schedule, or the like. In some embodiments, the transportation resource 125 can comprise one or several servers that can be, for example, located within the mode of transit, in communication with the mode of transit, and/or separate from the mode of transit.

A user can access and/or use the transit system 100 in a variety of ways. In some embodiments, for example, the user can access the transit system 100 via the mobile device 180 and/or via one or several of the station systems 130

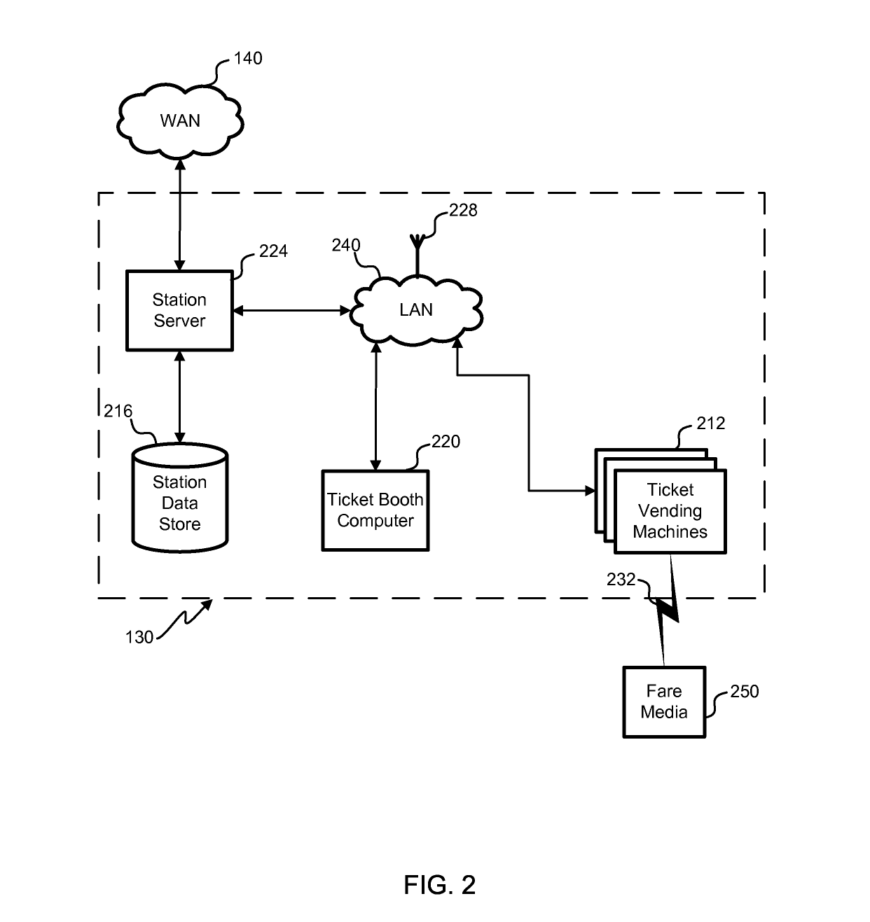

FIG. 2 shows a block diagram of an embodiment of a station system 130. In some embodiments, the station system 130 can control ticketing operations and/or other operations relating to and/or involving the transit system 100. In some embodiments, the station system 130 can be associated with a specific geographic location such as, for example, a train station, an airport, a subway station, a bus station, a dock, a harbor, a retail location and/or any other location, and in some embodiments, the station system 130 can be associated with a mode of transit such as, for example, a bus, train, taxi, a boat, ferry, an airplane, a lift, and/or any other mode of transit.

As discussed above, the transit system 100 can include various forms of transit, such as subway, bus, ferry, commuter rail, para-transit, and more. Because different forms of transit may require different functionality, various station systems 130 may have some or all of the components shown in the block diagram. The components of the station system 130 can be communicating the linked to each other so as to allow the sending and receiving of information between the components of the station transit system 130. In some embodiments, this link can comprise a wired and/or wireless network. In the embodiment shown in FIG. 2, the components of the station system 130 can be linked by a local area network (LAN) 240. The local area network (LAN) 240 10 couple the various systems together and can include point-to-point connections, packet switched connections, wireless connections, and/or other networking techniques.

The station transit system 130 can include a station server 224 that can be coupled to the WAN 140 to allow communication with the central ticketing system 112. Processing of local information can be performed on the station computer server 224. For example, fare information, schedule information, delay update information, and other transit related information can be processed at the station server 224 and communicated to the various other machines in the transit system 100.

A ticket booth computer 220, and transit vending machines (TVMs) 212 can communicate with the central ticketing system 112 through the station computer server 224 or directly with the central ticketing system 112 through LAN 240 or WAN 140 (e.g., the Internet).

The TVMs 212, and one or more ticket booth computers 220, can communicate with the station server 224 via the LAN 204. This communication can be transmitted via a physical connection or wireless connection via one or more antennas 228. Transactions at access control points 208, TVMs 212, and one or more ticket booth computers 220 can be communicated to the station server 224, stored at station data store 216, and/or transmitted to central ticketing system, which can update information in a transit user account accordingly.

Various portable and/or handheld media with a unique identifier can be used as fare media, whether or not the media is issued by a transit services provider. Such media can include identification cards, payment cards, personal electronic devices, bar codes and items having bar codes, contactless devices, and more. Contactless devices can include media having a unique identification code readable by access control points though NFC signals (e.g., radio frequency (RF) signals). By way of example, but not by limitation, such contactless devices can include devices comprising RFID tags and/or RFID-tagged items, contactless payment cards (including but not limited to credit cards, prepaid cards, debit cards, or other bank cards or contactless smart cards.), contactless identification cards and/or fobs, and NFC-enabled mobile devices.

Fare media 250 can have multiple sources of information, which may be read automatically by certain systems and devices in the transit system 100, depending on desired functionality. For contactless devices, such sources can include an IC, memory, and/or contactless interface of the device. Additionally or alternatively, contactless devices and other forms of fare media 250 can include a magnetic stripe, a bar code, and/or data imprinted and/or embossed on the device, which can serve as additional sources of information. Contactless and other sources of information can serve as repositories of account information related to, for example, a financial or user account associated with the fare media 250 (which may not be associated with the transit system 100).

TVMs 212 may interact directly with a fare media 250 through, for example, a contactless connection 232. Although communication of the contactless connection 232 may be two way, fare media 250 may simply communicate an identification code to TVM 212. This can be done, for example, to authenticate a contactless device for use as fare media 250 in the transit system 100. A contactless device does not have to be issued by a transit service provider in order to be authenticated and used as fare media 250 in the transit system, as long as the information communicated by the fare media 250 to the TVM 212 (and subsequently to access control points 208 for passage in the transit system 100) serves to uniquely identify the fare media 250. Such an authentication process is provided in greater detail below.

All or part of the information communicated by the fare media 250 can be used as an identification code to identify the transit fare media 250. This identification code can comprise one or more fields of data including or based on information such as a name, a birth date, an identification number (such as a PAN), a social security number, a driver's license number, a media access control (MAC) address, an electronic serial number (ESN), an international mobile equipment identifier (IMEI), and more. Because the identification code is unique, it can be associated with a transit user account, and utilized by a user at a TVM 212 to access and/or update information associated with the transit user account.

In some instances, an identification code may be assigned by a transit service provider and written to the fare media 250, such as an NFC-enabled mobile device 280. For example, a transit application running on an NFC-enabled phone can generate or otherwise provide an identification code to be transmitted from the phone at access control points of the transit system 100. In other instances, if TVM 212 is utilized to enable a user to create a transit user account, the TVM 212 may also write an identification code to an unused portion of a memory of the fare media, such as integrated circuit chip file space on a smart card or an NFC component on the NFC-enabled mobile device 280.

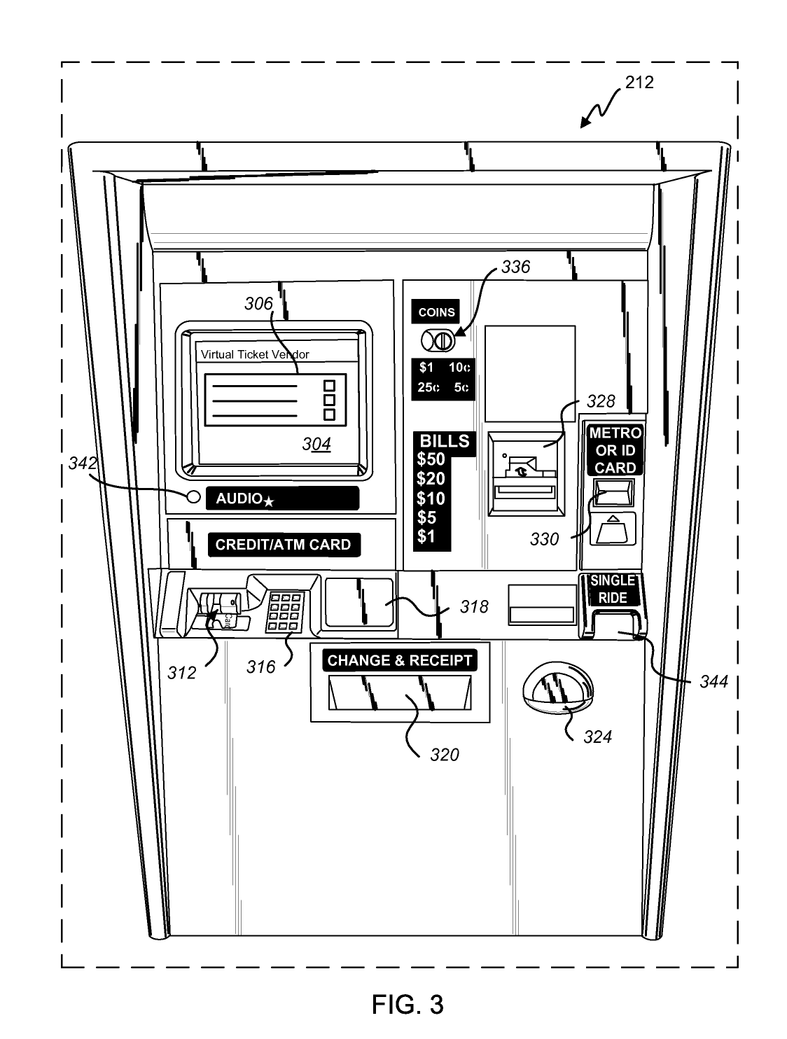

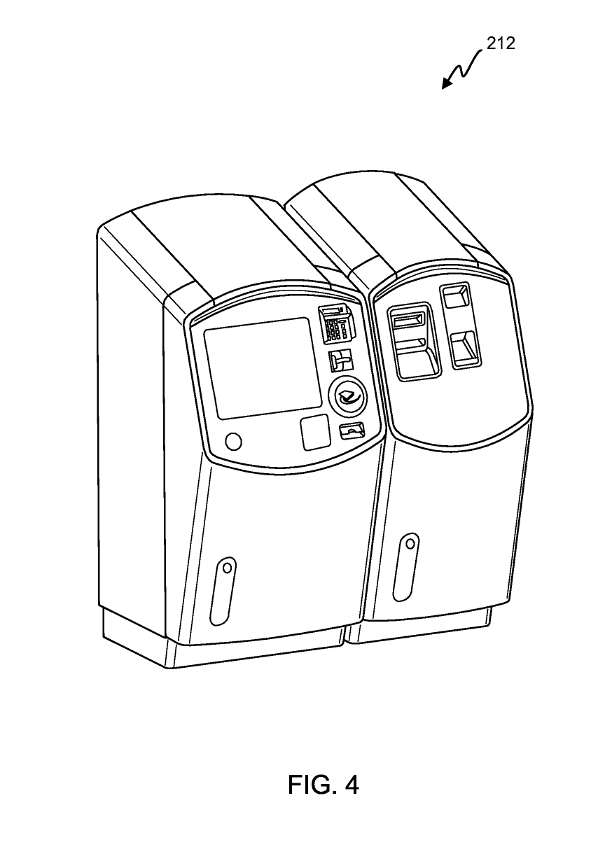

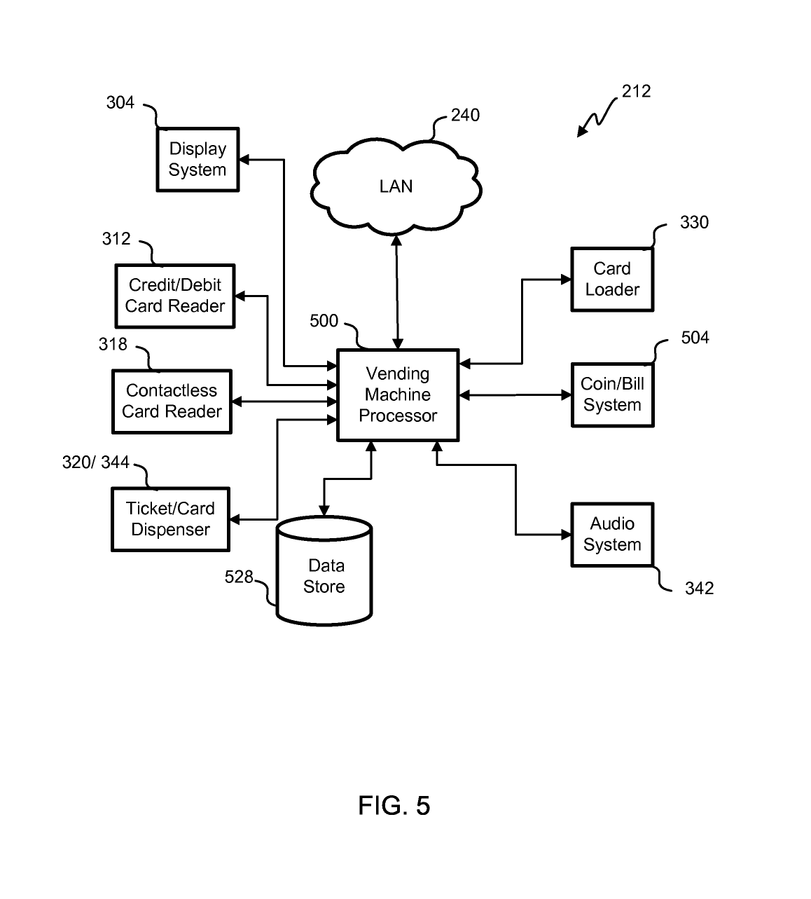

In FIGS. 3-5, perspective views and schematic illustrations of embodiments of a TVM 212 are shown. The TVM 212 can facilitate the vending of tickets and the completion and performance of a transaction between the user and the station system 130. The TVM 212 can comprise a variety of shapes and sizes and can include any desired combination of the following listed optional components. Thus, and by way of example, the TVM 212 shown in FIG. 3 has a shape that is different than the TVM 212 shown in FIG. 4, and can similarly include features and/or components that are different than those of the TVM 212 shown in FIG. 4.

The TVM 212 can include a vending machine processor 500 that can be coupled to the other components of the TVM 212 and can transmit and/or receive signals to and from the other subsystems to cause the other components to perform their intended functions. Fare cards can be purchased and/or reloaded with value at the TVM 212. A coin/bill system 504, magnetic stripe card reader 312, and contactless card reader 318 can be used to make payments for transactions at the TVM 212. Additionally or alternatively, a contactless card reader 318 may be coupled with a magnetic stripe card reader 312 to enable simultaneous reading of contactless and magnetic stripe information. A keypad 316 can be provided adjacent to the credit/debit card reader 312 to enter numerical information such as a PIN code for a debit card. A coin slot 336 and bill loader 328 can be used to accept cash. Change can be returned in a change/receipt slot 320 and coin return 324. Reloadable fare cards and receipts, including receipts having a activation code, can also be provided in the change/receipt slot. TVM 212 may further dispense single-ride fare cards through card dispenser 344, which is coupled with a card storage unit (not shown) storing reloadable prepaid cards for distribution. Information regarding transactions may be communicated through a LAN 240 by the vending machine processor 500 using, for example, a network interface (not shown).

Information regarding transactions may be communicated to various entities. For example, a contactless PAN, a magnetic stripe PAN, and/or other information may be communicated to the central ticketing system 112 to create a transit user or temporary account. Additionally or alternatively, a PAN and other payment information may be transmitted to a card issuer or other financial institution 160 for payment of a transit product. The financial institution 160 can receive communication from TVM 212 via financial network 150, central ticketing system 112, and/or WAN 140. Moreover, a financial account associated with a contactless payment card 310 may comprise a funding source 165 maintained by a financial institution 160.

A display system 304 prompts the card holder through the refill/purchase process. For example, the screen prompts the purchaser to touch a start button/icon on a touch screen display of the display system 304 to begin the process. A textual display portion 306 can display textual instructions for the user after the process has begun. Additionally or alternatively, an audio system 342, including a speaker, can produce audio commands. The user can be given a menu of choices of how to proceed. For example, the menu may include choices to purchase or reload a reloadable fare card, purchase a single-ride fare card, purchase a product, setup a transit user account, and/or associate a contactless device, such as a contactless payment card, with a transit user account. It will be understood that, additionally or alternatively to a touch screen display, other input interfaces may be utilized to accept input from a user. This can include, but is not limited to a touchpad, keyboard, mouse, trackball, audio input interface, joystick, etc.

If the user chooses an option requiring payment, the user may be instructed, by menu prompts, pre-recorded video and/or audio, on how to proceed with the payment. The user can be given a choice to pay in cash or by a payment card. For cash purchases, the user can be instructed to insert coins or bills into the coin slot 336 or the bill loader 328. For payment card purchases, the user can be instructed to insert payment card into the magnetic stripe card reader 312, or touch a contactless payment card 310 to contactless card reader 318.

Different processes may be implemented if the user chooses to enable a contactless payment card 310 as fare media 250. For example, the user can be instructed to touch a contactless payment card 310 to contactless card reader 318. Additionally, the user can be instructed to insert the contactless payment card 310 into the magnetic stripe card reader 312 and/or input the imprinted and/or embossed PAN 314 by using the keypad 316, the display system 304 (if it includes touchscreen capabilities), or both. Alternatively, for TVMs 212 with a contactless card reader 318 coupled with a magnetic stripe card reader 312, a user can be instructed to insert the contactless payment card 310 into the magnetic stripe card reader 312, allowing the TVM 212 to read both the contactless and magnetic stripe information from the contactless payment card 310. The TVM 212 can be configured to provide additional functions such as allowing the user to purchase a product, activate the contactless payment card 310 as fare media 250, and/or create a transit user account, by, for example, accepting additional input through any one of the user interfaces described above. Additionally or alternatively, the TVM 212 can simply print out an activation code on a receipt and provide the receipt to the user from the change/receipt slot 320. The transit system 100 can associate the activation code with information collected from the contactless payment card 310, enabling the user to perform any of the additional functions listed above at a TVM 212, ticket booth, website and/or other system at a subsequent point in time.

It will be understood that any or all of the features and/or capabilities of the TVM 212 described above may be included in other locations and/or devices of the transit system 100. It will be further understood that a TVM 212 can include more or fewer components than those depicted in FIGS. 3-5 and discussed above. A user may therefore register a contactless device, such as a contactless payment card 310, as fare media at other locations of the transit system 100. For example ticket booth computers 220 can be coupled with contactless card readers and/or magnetic stripe card readers, allowing a user to perform any or all of the functions described above by providing a contactless payment card 310 to a transit worker at a ticket booth. Additionally or alternatively, other devices may be configured to read contactless and magnetic stripe information from a contactless payment card 310 and transmit the information to a central ticketing system 112 of the transit system 100, without having the additional functionality of a TVM 212. Such devices further can be configured to print a receipt with an activation code, enabling a user to complete, at a later point in time, the process of activating a contactless payment card 310 for use as fare media 250. Moreover, these procedures may be carried out at a sales office, automated teller machine, and/or other manned or unmanned locations.

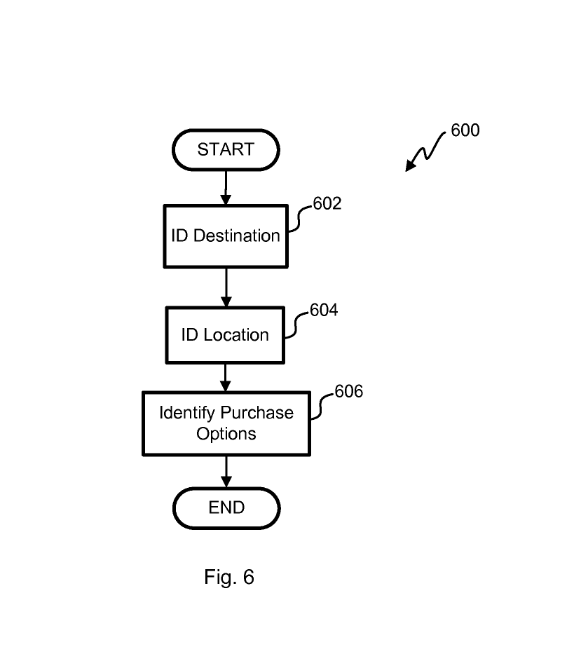

With reference now to FIG. 6, a flowchart illustrating one embodiment of a process 600 for onboard onwards travel ticketing is shown. In some embodiments, the process 600 can include steps for determining information relating to the user, the destination of the user, purchase options relevant to the user's destination, and/or information relating to the time of the user's arrival at the destination and/or, in the event that the relevant purchase options relate to modes of transit, information relating to the time of the arrival and/or departure of the modes of transit from the user's destination. In some embodiments, the process 600 can be performed by the transit system 100 and/or components thereof. In one specific embodiment, the process 600 can be performed by the station system 130 and/or components thereof.

Process 600 begins at block 602 wherein the destination is identified. In some embodiments, the destination can be identified by information received from the user, with stored information relating to the user, and/or with stored information relating to traveler patterns on the current mode of transit. In some embodiments, the destination can include destinations of the current mode of transit, and in some embodiments, the destination can include destination reachable with the current mode of transit in combination with another mode of transit. Similarly, in some embodiments, the destination can comprise a final destination that is the destination that is the object of the transit, and in some embodiments, the destination can comprise an intermediate destination, which intermediate destination can comprise all non-final destinations, and can include, for example, a transfer destination, a layover destination and/or any other similar transitory and/or non-final destination.

In one embodiment, for example, the user can provide information that identifies the user's destination. In one embodiment, the transit system 100 can use information relating to the user's past travel and/or to other travelers to identify one or several potential destinations. In some embodiments, a subset of these potential destinations can be can be selected and provided to the user. In one embodiment, the subset can be selected according to, for example, destinations to which the current mode of transit is traveling, distance, time, cost, or the like. These potential destinations and/or the limited potential destinations can then be provided to the user, and a user input can be received identifying one or several of the potential destinations.

After the destination has been identified, the process 600 proceeds to block 604 wherein the location is identified. In some embodiments, the location comprises the current location of the user and/or of the mode of transit in which the user is. In some embodiments, the location can be determined by components within the TVM 212, by one or several user operated devices, and/or by components of the mode of transit.

After the location has been identified, the process 600 proceeds to block 606 wherein purchase options are identified. In some embodiments, for example, purchase options can comprise purchasable goods and/or services associated with the destination and/or associated with travel from the destination. In some embodiments, all of the available purchase options can be filtered so as to create a subset of purchase options for the user. This subset of purchase options can be filtered according to a bounding rule which can filter purchase options based on location, time, distance, price, types of good and/or services provided, and/or the like. In some embodiments, purchase options can be can be identified by one or several components of the TVM 212, the station system 130, and/or the transit system 100.

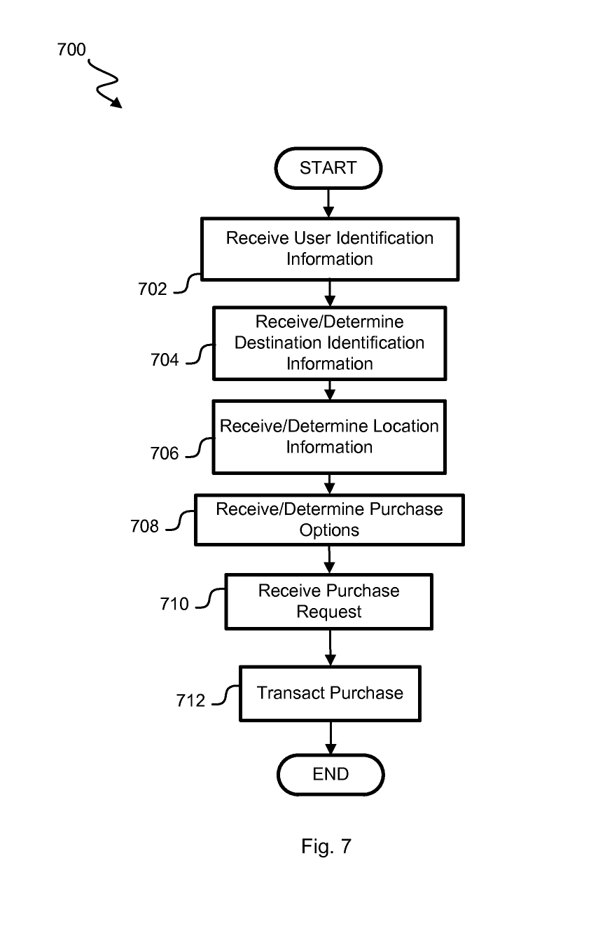

With reference now to FIG. 7, a flowchart illustrating a detailed embodiment of a process 700 for onboard onwards travel ticketing is shown. As seen in FIG. 7, process 700 includes more steps and process 600 than shown in FIG. 6. In some embodiments, the process 700 can be performed in the place of process 600 and/or in addition to process 600. In some embodiments, steps from process 600 and process 700 can be combined and/or mixed. In some embodiments, process 700 can be performed by transit system 100 and/or components thereof including, for example, station system 130 and/or the TVM 212.

Process 700 begins at block 702 wherein user identification information is received. In some embodiments, for example, user identification information can identify the user. The user identification information can identify the user via the identification of the user account. In some embodiments, this identification can include the providing of one or several of the username, user password, the user identification number, and/or the like. In some embodiments, for example, user identification information can be stored on the object such as, for example, a card, a fob, and/or the like. In some embodiments, user identification information can be stored in any desired format including, for example, as a text string, as computer readable code, as magnetic code, within a chip, and/or within a radio signal generating feature such as, for example, an RFID chip.

After the user identification information has been received, the process 700 proceeds block 704 wherein user destination information is received and/or determined. In some embodiments, for example, and as discussed above, this information can relate to one or several final and/or intermediate destinations. This information can be received via a direct user input, and in some embodiments this information can be received from other components of the transit system 100. In one embodiment, for example, the user destination information can be received from the TVM 212 from which the user purchase a ticket and/or fare covering the current transit.

In some embodiments, for example, destination information can be determined. This determination can be performed by component of the transit system 100 based on information gathered and/or stored by the transit system 100. In some embodiments, this determination can include the filtering of stored information to identify a relevant and/or desired subset of the stored information. The stored information can be filtered according to a parameter of the current travel such as, the time and/or date of the current travel, the type of mode of transit being used for the travel, the current location of the mode of transit, and/or the like. In some embodiments, the stored information can be filtered according to one or several user parameters and/or one or several parameters of the travelers associated with the stored information. Thus, in one embodiment, the stored data is filtered according to similarities between the current user and the one or several travelers creating the stored data.

In some embodiments, for example, information relating to past user destinations can be retrieved and can be used to identify one or several potential destinations. The past user destinations can be destinations that have been previously travelled to by the user. In some embodiments, these past user destinations can be filtered according to time, date, and/or mode of transit. These potential destinations can be provided to the user, and the user can then provide an input identifying the correct destination.

In some embodiments, for example, information relating to frequent destinations of other travelers can be retrieved and can be used to determine one or several potential destinations for the user. In such an embodiment, stored destination information can be retrieved and can be filtered for relevance according to one or several of: current time, mode of transit, current transit location, weekday, date, and/or the like. In some embodiments, for example, the stored destination information can be filtered according to one or several parameters relating to the current user. In some embodiments, for example, user parameters such as user's age, gender, hobbies, profession, employer, socioeconomic data, and/or any other information identifying a desired aspect of the user can be used to filter data stored within the transit system 100. The data stored within the transit system 100 can be filtered such that information for travelers similar to the current user is identified and used to determine potential destinations.

After the destination information has been received and/or identified, the process 700 proceeds to block 706 wherein location information is received and/or determined. In some embodiments, receiving and/or determination the location information can include identifying the location of the mode of transit, the direction of travel of the mode of transit, and the rate of travel of the mode of transit. In some embodiments, this step can be performed by the transit system 100 and/or a component of the transit system 100. In some embodiments, this step can be performed by components external to transit system 100 including, location identification features of one or several mobile devices 180, and/or location identification features associated with the mode of transit. One embodiment, for example, a location identification feature can be located within the station system 130. This feature can be used to determine the current location of the mode of transit, and can comprise, for example, a Global Positioning System (GPS) unit and/or the like. In some embodiments, the station system 130 can use the GPS unit to determine the location of the mode of transit. In some embodiments, the station system 130 can query components and/or features in communication with one or several mobile devices 180 and/or with features associated with the mode of transit for location information. In such an embodiment, a location identification feature such as, for example, Global Position System (GPS) unit located within one or both of mode of transit and/or one or several mobile devices 180 can determine the location of the mode of transit, and this information can be provided to the station system 130.

After the location information has been received and/or determined, the process 700 proceeds to block 708 wherein purchase options are determined and/or received. In some embodiments, this step can include identifying one or several purchase options associated with the destination and identifying a subset of these purchase options. In some embodiments, for example, this subset can be identified according to one or several bounding, or filtering rules. In some embodiments, these bounding, or filtering rules identify parameters for determining the inclusion of purchase options within the identified subset. In some embodiments, for example, these filtering rules can be based on distance, time, price, category and/or type good or service, or any other similar parameter. In some embodiments, information relating to these purchase options can be received by the TVM 212 from another component of the transit system 100, and in some embodiments, information relating to these purchase options can be received from a source external to the transit system 100.

After the purchase options have been received and/or determined, the process 700 can proceed to block 710 wherein a purchase request is received. In some embodiments, the purchase request can be received from the user via the TVM 212 and/or be another component of the station system 130. In some embodiments, for example, the user can use a mobile device 180 to provide this purchase request. In some embodiments, the purchase request can identify one or several of the purchase options for purchase. These can include, for example, purchase of further transportation and/or the purchase of other goods or services.

After the purchase request is received, the process 700 proceeds to block 712 wherein the purchase is transacted. In some embodiments, for example, this step can be performed by the TVM 212 by communicating with other components of the transit system 100 and/or the station system 130. In some embodiments, for example, this transaction can include querying, via the financial network 150 one or several financial institutions 160 for payment information from the user.

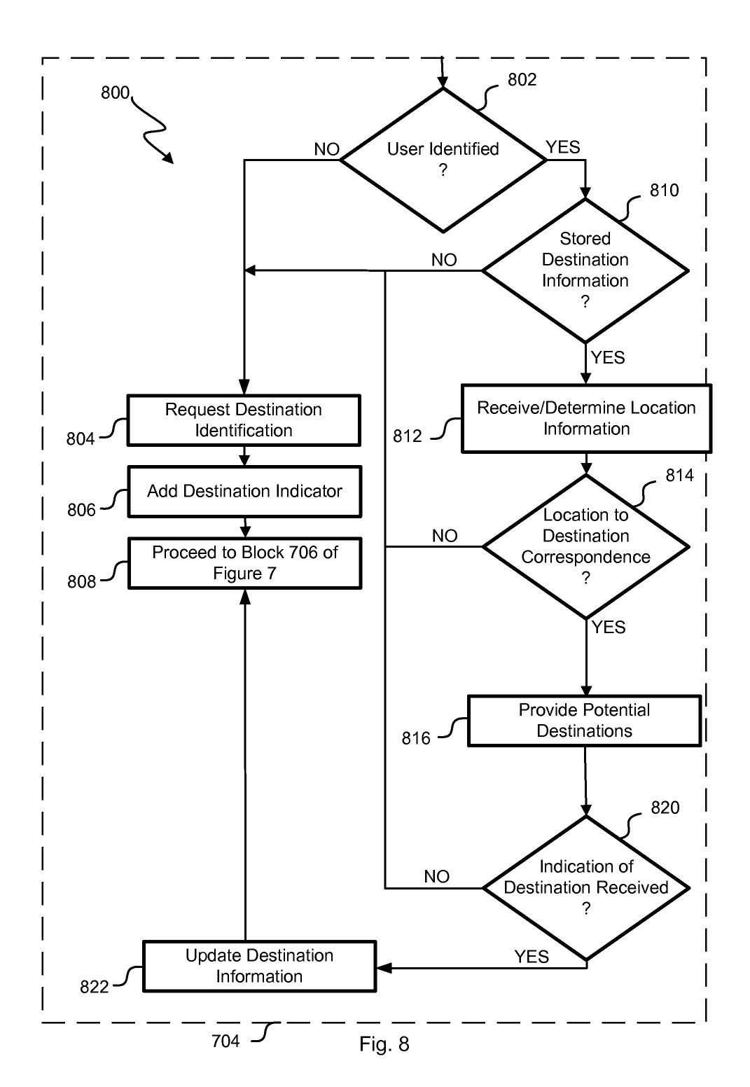

With reference now to FIG. 8, a flowchart illustrating one embodiment of the process 800 for receiving and/or determining destination information is shown. In some embodiments, this process 800 can be performed in the place of, and/or as a component of block 704 depicted in FIG. 7. This process can be performed by the TVM 212, the station system 130, the transit system 100, and/or by a component of one of these.

The process 800 begins at decision state 802 wherein it is determined if the user is identified. In some embodiments this determination can include determining whether the user has provided information that identifies the user. If the user has not been identified, then the process 800 proceeds to block 804 wherein identification of the users destination is requested. In some embodiments, this request can be made by the TVM 212, and specifically by, for example, the display system 304 and/or the audio system 342.

After the identification of the destination has been requested, the process 800 proceeds to block 806 wherein a destination indicator is added. In some embodiments, this step can include receiving identification of the destination from the user via, for example, the station system 130 and/or the TVM 212. The destination indicator can provide an indication of the received destination identification. In some embodiments, the destination indicator can be added to memory associated with the transaction. After the destination indicator has been added, the process 800 proceeds to block 808 and returns to block 706 of FIG. 7.

Returning again to decision state 802, if the user is identified, then the process 800 proceeds to decision state 810 wherein it is determined if destination information is stored. In some embodiments, for example, stored destination information can include information relating to the user's past destinations and/or to destination information of other travelers. In some embodiments, the destination information can comprise the name of one or several destinations, the location of one or several destinations such as, for example, accordance with one or several destinations, and/or the like. In some embodiments, destination information can be stored within the transit system 100, and in some embodiments can be stored within the station system 130 and/or the TVM 212. If it is determined that no destination information is stored, then the process 800 proceeds to block 804 and progresses as outlined above.

If it is determined that destination information is stored, then the process 800 proceeds to block 812 wherein location information is received and/or determined. In some embodiments, the receipt and/or determination of location information can be performed by the TVM 212, the mode of transit, and/or one or several user devices including, mobile devices 180. In some embodiments, this determination can include using, for example, a GPS unit to determine the present location of the mode of transit, direction of travel of the mode of transit, and/or speed of travel of the mode of transit. In some embodiments, this step can further include identifying a route associated with the mode of transit. In some embodiments, for example, this can include receiving information identifying the route associated with the mode of transit, and in some embodiments, this can include identifying one or several potential routes that correspond with the location and direction travel of the mode of transit. In such an embodiment, the location the direction of travel of the mode of transit can be compared to a database of existing routes, and a subset of the existing routes can be identified based on which of the existing routes passes through the identified location and has the same direction of travel as the mode of transit. In some embodiments, the step in block 812 can be the same as the step in block 706 of FIG. 7, and in some embodiments, the second block 812 can be performed separate from the step in block 706 of FIG. 7.

After the location information has been determined and/or received, the process 800 proceeds to decision state 814 wherein it is determined if there is a correspondence between the location and stored destination information. In some embodiments, this can include identifying a subset of relevant stored destination information. In some embodiments, the relevant stored destination information can comprise information identifying one or several destinations. In some embodiments, these one or several destinations can be reached via the current mode of transit and/or via the current mode of transit in combination with one or several other modes of transport.

As every destination may be reached via a combination of the current mode of transit and one or several other modes of transport, in some embodiments, the scope of relevant stored destination information can be defined by one or several bounding rules. These bounding rules can define, for example, conditions used to include destination information in and/or exclude stored destination information from the subset of relevant stored destination information. In some embodiments, these bounding rules can, for example, identify the subset of relevant stored destination information by limiting the number of transfers allowed between mode of transit, identifying a maximum travel time and/or travel distance from the current location, and/or any other desired parameter. In some embodiments, a location to destination correspondence is identified if a subset of relevant stored destination information is identified, and in some embodiments, a location to destination correspondence is not identified if a subset of relevant stored destination information is not identified. If a location to destination correspondence is not identified, then the process 800 proceeds to block 804 and continues as outlined above.

If the location to destination correspondence is identified, then the process 800 proceeds to block 816 wherein potential destinations are provided. In some embodiments, this step can comprise identifying the one or several destinations within the subset of relevant stored destination information, and providing the one or several destination within the subset of relevant stored destination information to the user. In some embodiments, these destinations can be provided to the user via the TVM 212 and/or via a mobile device 180.

After the potential destinations are provided to the user, the process can proceed to decision state 820 wherein it is determined if an indication of destination is received. In some embodiments, for example, a plurality of potential destinations can be provided to the user and the user can be allowed and/or prompted to select one of the potential destinations. In such an embodiment, if the user does not provide a selection of the destination from the list of potential destinations, then indication of destination is not received and the process proceeds to block 804 and continues as outlined above.

If the user does provide a selection of the destination from the list of potential destinations, and the indication of destination is received, the process 800 proceeds to block 822 wherein the destination information is updated. In some embodiments, the selection of the user destination can be stored, and in some embodiments, the selection of the user destination can be stored with stored destination information. Advantageously, the storage of this information can improve the quality and completeness of the stored destination information. Further, such improvement of the database can facilitate in providing more accurate identification of potential destinations. After the destination information has been updated, the process 800 proceeds to block 808 and proceeds to block 706 of FIG. 7.

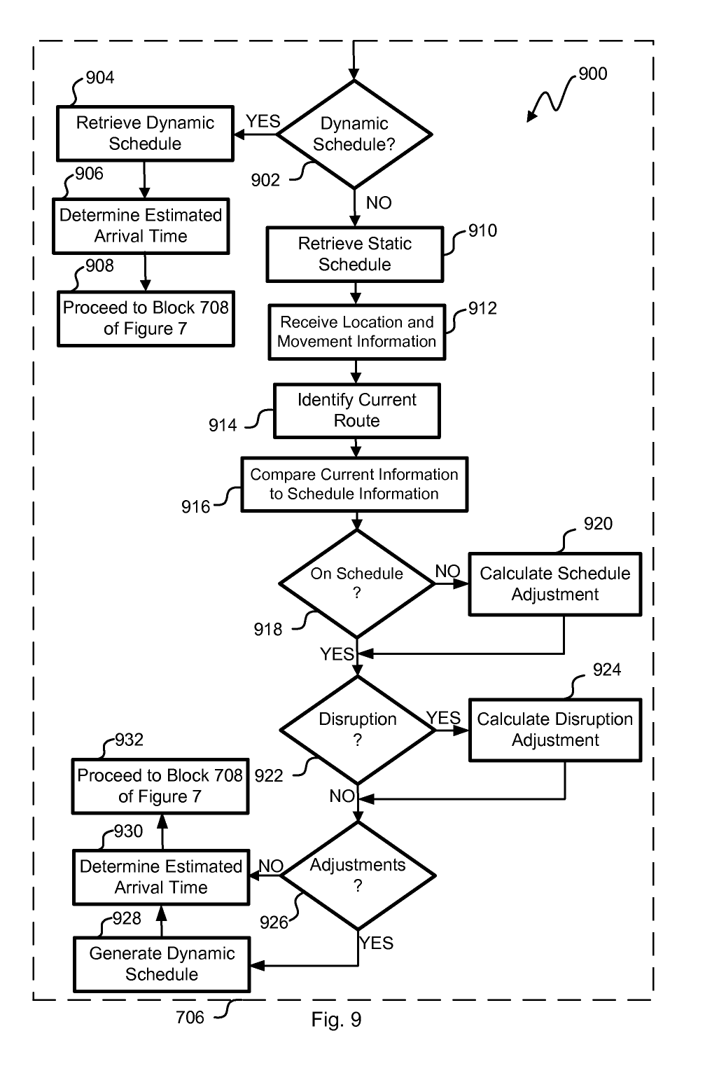

With reference now to FIG. 9, flowchart illustrating one embodiment of a process 900 for receiving and/or determining location information is shown. In some embodiments, this process 900 can be performed in the place of, and/or as a component of block 706 depicted in FIG. 7. This process can be performed by the TVM 212, the station system 130, the transit system 100, and/or by a component of one of these.

The process begins at decision state 902 wherein it is determined if there is a dynamic schedule. In some embodiments, the schedule can comprise one or both of a static schedule and a dynamic schedule. A static schedule can include data identifying one or several locations, one or several modes of transport to the one or several locations, and/or arrival and/or departure data for the modes of transport to the one or several locations. The dynamic schedule can include similar information, however, the information in the dynamic schedule can include disruption information, which disruption data can relate to any circumstances or conditions that will result in and/or have resulted in an arrival and/or departure time deviation from the static schedule. Thus, the static schedule reflects the normal operation of one or several modes of transport and the dynamic schedule reflects the actual operation of one or several modes of transport.

If it is determined that there is no dynamic schedule, then the process 900 proceeds to block 904 wherein the dynamic schedule is retrieved. In some embodiments, for example, the dynamic schedule can be retrieved from, for example, the transportation resource 125 and/or any other source external to and/or located within the transit system 100. In some embodiments, for example, the dynamic schedule can be retrieved from the operator of the mode of transit.

After the dynamic schedule has been retrieved, the process 900 can proceed to block 906 wherein an estimated arrival time is determined. In some embodiments, this determination can include searching the dynamic schedule for arrival information for the desired destination.

Returning again to decision state 902, if it is determined that there is no dynamic schedule, then the process 900 proceeds to block 910 wherein the static schedule is retrieved. In some embodiments, the static schedule can be retrieved from any source of the static schedule including, for example, sources within the transit system 100 including, for example, the station system 130 and/or the TVM 212. In some embodiments, the static schedule can be retrieved from a source external to the transit system 100 including, for example, the transportation resource 125.

After the static schedule has been retrieved, the process 900 proceeds to block 912 wherein location and movement information is received. In some embodiments, for example, this can include the receipt of information identifying the current location mode of transit and/or the direction of travel of the mode of transit. In some embodiments, this can include receiving identification of the current route of the mode of transit and/or of current potential routes of the mode of transit. This information can be received from one of the components of the transit system 100 including, for example, a GPS unit within the TVM, within the mode of transit, and/or within one of the mobile devices 180.

After the location and movement information has been received, the process 900 proceeds to block 514 wherein the current route is identified. In some embodiments in which the current route is not identified, and/or a plurality of potential current routes are identified, the current route can be identified based on information relating to the current location of the mode of transit, stops of the mode of transit, and/or scheduled stops of one or several routes. In some embodiments, the data relating to the mode of transit can be compared to data for one or several potential routes until a matching route is identified. In the event that a plurality of matching routes are identified, route information can be received from, for example, the transportation resource 125 and/or from the mode of transit.

After the current route has been identified, the process 900 proceeds to block 916 wherein the current mode of transit information is compared to schedule information. In some embodiments, for example, this can include the comparison of current location and time data for the mode of transit with location time data predicted by the static schedule. Thus, in one embodiment, a comparison between the location predicted by the static schedule and the current location of the mode of transit can be performed. This comparison can be performed by the transit system 100, station system 130 and/or a component thereof.

After the current information is compared to the schedule information, the process 900 proceeds to decision state 918 wherein it is determined if the mode of transit is on schedule. In some embodiments, this can include determining whether the mode of transit is at the location predicted by the static schedule. If the mode of transit is not at the location predicted by the static schedule, then the process 900 proceeds to block 920 wherein a schedule adjustment is calculated. In some embodiments, the schedule adjustment can comprise data indicating the difference between the current location of the mode of transit and the location predicted by the static schedule. In some embodiments, this discrepancy can be reflected in a measure of distance and/or in a measure of time indicative of the degree to which the mode of transit is ahead of and/or behind the static schedule.

After the schedule adjustment has been calculated, or, returning again to decision state 918, if it is determined that the mode of transit is on schedule, then the process 900 proceeds to decision state 922 wherein it is determined if there are any known disruptions that will occur between the current location of the mode of transit and the destination. In some embodiments, this determination can include receiving disruption information from one or several transportation resources 125, and generating a database of disruption information. In some embodiments, this database of disruption information can identify a location of disruption and a predicted and/or actual impact of the disruption on transportation. In some embodiments, this impact can be identified as a delay, and specifically as a delay quantified by, for example, a number of minutes. In some embodiments, a disruption that slows the progress of the mode of transit can be identified as increasing the duration of the travel time between the current location and the destination, and a disruption that speeds the progress of the mode of transit can be identified as decreasing the duration of the travel time between the current location in the destination.

If it is determined that there is a disruption between the current location the destination, the process 900 proceeds to block 924 and calculates disruption adjustment. In some embodiments, for example, this disruption adjustment can comprise an indicator of the affected the disruption on the movement of the mode of transit. In some embodiments, this adjustment can be calculated by retrieving disruption information and applying it to the current mode of transit.

After the disruption adjustment has been calculated, or, returning again to decision state 922, if it is determined there is no disruption, then the process 900 proceeds to decision state 926 wherein this determined if there are any adjustments. In some embodiments, this can include determining whether a schedule adjustment has been calculated and/or whether a disruption adjustment has been calculated. If it is determined that there are adjustments, then the process 900 proceeds to block 928 wherein a dynamic schedule is generated. In some embodiments, the dynamic schedule can be generated by applying the calculated adjustments to the static schedule. This can be performed by the transit system 100, by the station system 130, by the TVM 212, and/or by a component of one of these.

After the dynamic schedule has been generated, or, returning again to decision state 926, if it is determined that there are no adjustments, the process 900 proceeds to block 930 wherein an estimated arrival time it is determined. In some embodiments, this estimated arrival time can be determined by acquiring the dynamic schedule for arrival time information. After the estimated arrival time has been determined, the process 900 proceeds block 932 and proceeds to block 708 of FIG. 7.

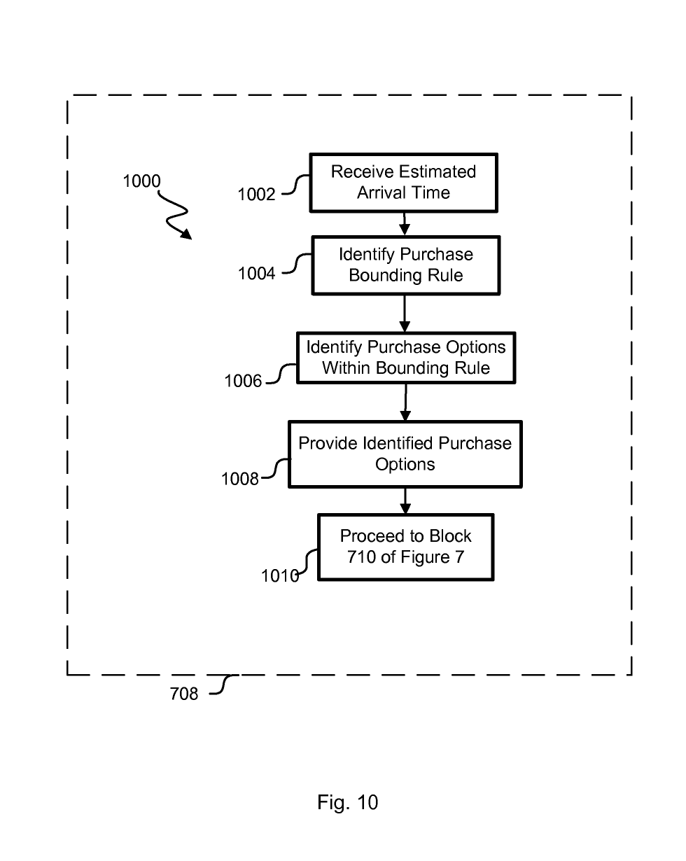

With reference now to FIG. 10, a flowchart illustrating one embodiment of a process 1000 for receiving and/or determining purchase options is shown. In some embodiments the process 1000 can be configured to identify a subset of one or several relevant purchase options from a set of purchase options. In some embodiments, the subset of relevant purchase options can be identified by applying one or several bounding rules to the set of purchase options. In some embodiments, this process 1000 can be performed in the place of, and/or as a component of block 708 depicted in FIG. 7. This process can be performed by the TVM 212, the station system 130, the transit system 100, and/or by a component of one of these.

The process 1000 can begin at block 1002 wherein an estimated arrival time is received. In some embodiments, the estimated arrival time can be received from the component of the transit system 100, and in some embodiments, the estimated arrival time can be received by querying the dynamic schedule for the estimated arrival time. After the estimated arrival time has been received, the process 1000 proceeds to block 1004 wherein a purchase bounding rule is identified. In some embodiments, the purchase bounding rule can either exclude or in include purchase options according to one of the distance from the destination, a time relative to the arrival at and/or departure from the destination, a price, a type of good and/or service, or any other desired parameter. In some embodiments, for example, the bounding rule can provide for: the inclusion of purchase options that are accessible within a specified distance of the destination, the inclusion of purchase options that are available within a specified time frame and/or can be accessed and/or consumed within the specified timeframe, and/or the inclusion of one or several purchase options having a price above or below a threshold value. In some embodiments, the bounding rule can be stored in a component of the transit system 100, within the station system 130, within the TVM 212, and/or within a component of one of these.

After the purchase bounding rule has been identified, the process 1000 proceeds to block 1006 wherein purchase options within the bounding rule are identified. In some embodiments, purchase options within the bounding rule can be identified by comparing a parameter of the purchase options with the bounding rule. In some embodiments, this comparison can be performed according a Boolean function, wherein a first value is assigned if the purchase option is identified as within the bounding rule, and a second value is assigned if the purchase option is identified as outside of the bounding rule. In some embodiments, the assigned Boolean value can be stored in association with the identified purchase option. In some embodiments, the identified purchase options can then be sorted according to a bounding rule, and specifically according to the assigned Boolean value.

After purchase options within the bounding rule are identified, the process 1000 proceeds to block 1008 wherein identified purchase options are provided. In some embodiments, the identified purchase options to be provided to the user via the transit system 100, the station system 130, the TVM 212, and/or a component of one of these. In one embodiment, the identified purchase options can be provided via the display system 304 and/or the audio system 342. After the purchase options are provided, the process 1000 proceeds to block 1010 and proceeds to block 710 of FIG. 7.

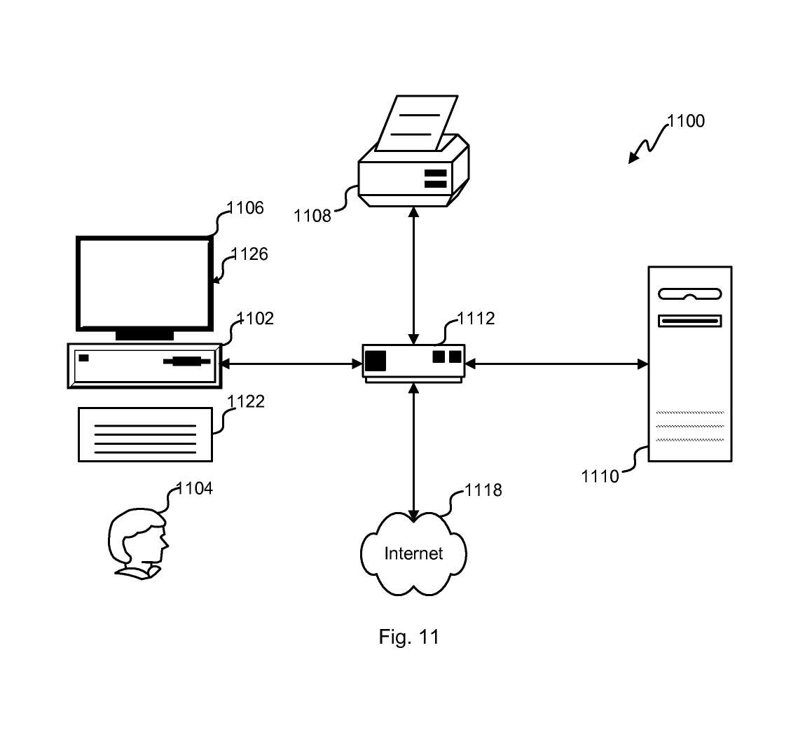

With reference now to FIG. 11, an exemplary environment with which embodiments may be implemented is shown with a computer system 1100 that can be used by a user 1104 as a component of the transit system 100. The computer system 1100 can include a computer 1102, keyboard 1122, a network router 1112, a printer 1108, and a monitor 1106. The monitor 1106, processor 1102 and keyboard 1122 are part of a computer system 1126, which can be a laptop computer, desktop computer, handheld computer, mainframe computer, etc. The monitor 1106 can be a CRT, flat screen, etc.

A user 1104 can input commands into the computer 1102 using various input devices, such as a mouse, keyboard 1122, track ball, touch screen, etc. If the computer system 1100 comprises a mainframe, a designer 1104 can access the computer 1102 using, for example, a terminal or terminal interface. Additionally, the computer system 1126 may be connected to a printer 1108 and a server 1110 using a network router 1112, which may connect to the Internet 1118 or a WAN.

The server 1110 may, for example, be used to store additional software programs and data. In one embodiment, software implementing the systems and methods described herein can be stored on a storage medium in the server 1110. Thus, the software can be run from the storage medium in the server 1110. In another embodiment, software implementing the systems and methods described herein can be stored on a storage medium in the computer 1102. Thus, the software can be run from the storage medium in the computer system 1126. Therefore, in this embodiment, the software can be used whether or not computer 1102 is connected to network router 1112. Printer 1108 may be connected directly to computer 1102, in which case, the computer system 1126 can print whether or not it is connected to network router 1112.

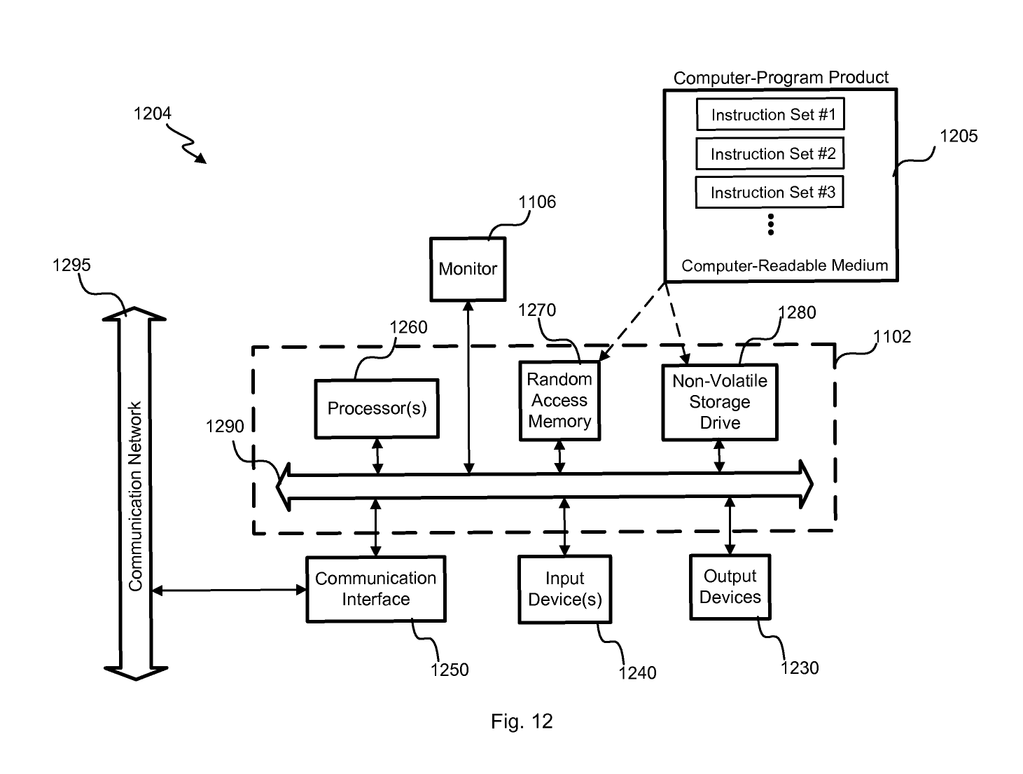

With reference to FIG. 12, an embodiment of a special-purpose computer system 1204 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 1126, it is transformed into the special-purpose computer system 1204.

Special-purpose computer system 1204 comprises a computer 1102, a monitor 1106 coupled to computer 1102, one or more additional user output devices 1230 (optional) coupled to computer 1102, one or more user input devices 1240 (e.g., keyboard, mouse, track ball, touch screen) coupled to computer 1102, an optional communications interface 1250 coupled to computer 1102, a computer-program product 1205 stored in a tangible computer-readable memory in computer 1102. Computer-program product 1205 directs system 1204 to perform the above-described methods. Computer 1102 may include one or more processors 1260 that communicate with a number of peripheral devices via a bus subsystem 1290. These peripheral devices may include user output device(s) 1230, user input device(s) 1240, communications interface 1250, and a storage subsystem, such as random access memory (RAM) 1270 and non-volatile storage drive 1280 (e.g., disk drive, optical drive, solid state drive), which are forms of tangible computer-readable memory.

Computer-program product 1205 may be stored in non-volatile storage drive 1280 or another computer-readable medium accessible to computer 1102 and loaded into memory 1270. Each processor 1260 may comprise a microprocessor, such as a microprocessor from Intel® or Advanced Micro Devices, Inc.®, or the like. To support computer-program product 1205, the computer 1102 runs an operating system that handles the communications of product 1205 with the above-noted components, as well as the communications between the above-noted components in support of the computer-program product 1205. Exemplary operating systems include Windows® or the like from Microsoft® Corporation, Solaris® from Oracle®, LINUX, UNIX, and the like.

User input devices 1240 include all possible types of devices and mechanisms to input information to computer system 1102. These may include a keyboard, a keypad, a mouse, a scanner, a digital drawing pad, a touch screen incorporated into the display, audio input devices such as voice recognition systems, microphones, and other types of input devices. In various embodiments, user input devices 1240 are typically embodied as a computer mouse, a trackball, a track pad, a joystick, wireless remote, a drawing tablet, a voice command system. User input devices 1240 typically allow a user to select objects, icons, text and the like that appear on the monitor 1106 via a command such as a click of a button or the like. User output devices 1230 include all possible types of devices and mechanisms to output information from computer 1102. These may include a display (e.g., monitor 1106), printers, non-visual displays such as audio output devices, etc.

Communications interface 1250 provides an interface to other communication networks 1295 and devices and may serve as an interface to receive data from and transmit data to other systems, WANs and/or the Internet 1118. Embodiments of communications interface 1250 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1250 may be coupled to a computer network, to a FireWire® bus, or the like. In other embodiments, communications interface 1250 may be physically integrated on the motherboard of computer 1102, and/or may be a software program, or the like.

RAM 1270 and non-volatile storage drive 1280 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1270 and non-volatile storage drive 1280 may be configured to store the basic programming and data constructs that provide the functionality of various embodiments of the present invention, as described above.

Software instruction sets that provide the functionality of the present invention may be stored in RAM 1270 and non-volatile storage drive 1280. These instruction sets or code may be executed by the processor(s) 1260. RAM 1270 and non-volatile storage drive 1280 may also provide a repository to store data and data structures used in accordance with the present invention. RAM 1270 and non-volatile storage drive 1280 may include a number of memories including a main random access memory (RAM) to store of instructions and data during program execution and a read-only memory (ROM) in which fixed instructions are stored. RAM 1270 and non-volatile storage drive 1280 may include a file storage subsystem providing persistent (non-volatile) storage of program and/or data files. RAM 1270 and non-volatile storage drive 1280 may also include removable storage systems, such as removable flash memory.

Bus subsystem 1290 provides a mechanism to allow the various components and subsystems of computer 1102 communicate with each other as intended. Although bus subsystem 1290 is shown schematically as a single bus, alternative embodiments of the bus subsystem may utilize multiple busses or communication paths within the computer 1102.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A system for dynamic ticket vending in an in-transit environment of a mode of transit, the system comprising:
a terminal comprising:
a user interface configured to allow the user to provide information to and receive information from the terminal; and
a processor configured to:
receive user destination information, wherein the user destination identifies at least one of:
an intermediate destination; and
a final destination; and
identify the current location of the mode of transit; and
a central ticketing system comprising:
a processor configured to:
receive current location information, wherein the current location information is received from the terminal;
generate a dynamic schedule, wherein the dynamic schedule identifies one of an adjusted arrival time and departure time for the mode of transit; and
identify relevant connection options according to the dynamic schedule and the destination information.

2. The system of claim 1, wherein the processor is configured to receive user destination information from one of the user and the user profile.

3. The system of claim 2, wherein the user profile identifies user transport patterns corresponding to the current mode of transit, the transport patterns comprising one of:
a previously purchase ticket; and
a previously visited destination.

4. The system of claim 1, wherein the current location of the mode of transit is identified by one of:
a location engine within the terminal;
a location feature within the mode of transit; and
the user's mobile device.

5. The system of claim 1, wherein the central ticketing system is configured to receive disruption information comprising an indication of a delay.

6. The system of claim 1, wherein one of the departure and/or arrival time is adjusted according to a disruption information.

7. The system of claim 1, wherein the relevant connection options are further identified according to a bounding rule, wherein the bounding rule identifies a criteria for identifying a connection option as one of the relevant connection options.

8. The system of claim 7, wherein the bounding rule identifies one of a distance limit, a time limit, and a price limit.

9. A method for dynamic ticket vending in an in-transit environment of a mode of transit, the method comprising:
identifying the current location of the mode of transit;
identifying a user destination, wherein the user destination comprises one of:
an intermediate destination; and
a final destination;
wherein identifying the user destination comprises:
identifying the user;
retrieving stored user destination information, wherein the stored user destination information identifies destinations visited by the user;
determining potential destinations for the mode of transit; and
comparing potential destination for the mode of transit with stored user destination information;
generating a dynamic schedule, wherein the dynamic schedule can comprise an estimated arrival time or an estimated departure time of the mode of transit at one or several locations based on collected information relating to the mode of transit; and
identifying relevant connection options according to the dynamic schedule and the destination information.

10. The method of claim 9, wherein the current location of the mode of transit is identified by one of:
a location engine within the terminal;
location information received from a transportation resource, wherein the location information received from the transportation resource is generated by the mode of transit; and
the user's mobile device

11. The method of claim 9, wherein the stored destination information comprises a user transport pattern that identifies previous destinations of the user.

12. The method of claim 9, wherein generating the dynamic schedule comprises receiving the static schedule.

13. The method of claim 12, wherein generating the dynamic schedule further comprises comparing the current location information of the mode of transit with location information predicted by the schedule; and
calculating a schedule adjustment based on the comparison of the current location information and the location information predicted by the schedule.

14. The method of claim 13, wherein generating the dynamic schedule further comprises receiving disruption information, wherein the disruption information identifies circumstances or conditions that will result in an arrival or departure time deviation from the static schedule;
calculating a disruption adjustment based on the disruption adjustment and the arrival or departure time predicted by the schedule.

15. The method of claim 14, wherein identifying relevant connection options further comprises identifying a bounding rule, wherein the bounding rule identifies a criteria for identifying a connection option as one of the relevant connection options, wherein the bounding rule comprises one of:
a distance limit,
a time limit,
and a price limit.

16. A non-transitory computer readable medium comprising code adapted to be executed to implement a method for dynamic ticket vending in an in-transit environment of a mode of transit, said method comprising:
identifying the current location of the mode of transit;
identifying a user destination, wherein the user destination comprises one of:
an intermediate destination; and
a final destination;
wherein identifying the user destination comprises:
identifying the user;
retrieving stored user destination information, wherein the stored user destination information identifies destinations visited by the user;
determining potential destinations for the mode of transit; and
comparing potential destination for the mode of transit with stored user destination information;
generating a dynamic schedule, wherein the dynamic schedule can comprise an estimated arrival time or an estimated departure time of the mode of transit at one or several locations based on collected information relating to the mode of transit; and
identifying relevant connection options according to the dynamic schedule and the destination information.

17. The non-transitory computer readable medium of claim 16, wherein the current location of the mode of transit is identified by one of:
a location engine within the terminal;
location information received from a transportation resource, wherein the location information received from the transportation resource is generated by the mode of transit; and
the user's mobile device

18. The non-transitory computer readable medium of claim 16, wherein the stored destination information comprises a user transport pattern that identifies previous destinations of the user.

19. The non-transitory computer readable medium of claim 16, wherein generating the dynamic schedule comprises receiving the static schedule.

20. The non-transitory computer readable medium of claim 19, wherein generating the dynamic schedule further comprises comparing the current location information of the mode of transit with location information predicted by the schedule; and
calculating a schedule adjustment based on the comparison of the current location information and the location information predicted by the schedule.

21. The non-transitory computer readable medium of claim 19, wherein generating the dynamic schedule further comprises receiving disruption information, wherein the disruption information identifies circumstances or conditions that will result in an arrival or departure time deviation from the static schedule;
calculating a disruption adjustment based on the disruption adjustment and the arrival or departure time predicted by the schedule.

22. The non-transitory computer readable medium of claim 21, wherein identifying relevant connection options further comprises identifying a bounding rule, wherein the bounding rule identifies a criteria for identifying a connection option as one of the relevant connection options, wherein the bounding rule comprises one of:
a distance limit,
a time limit,
and a price limit.
